(19) United States
(12) Patent Application Publication
(10) Pub. No.: US 2003/0099798 A1
(43) Pub. Date: May 29, 2003

(54) Nanocomposite reinforced polymer blend and method for blending thereof

(76) Inventors: Eric R. George, Orangeburg, SC (US); Robert L. Ballard, Orangeburg, SC (US)

Correspondence Address: Sperry, Zoda & Kane, Suite D, One Highgate Drive, Trenton, NJ, 08618, US

(21) Appl. No.: 10/011,659

(22) Filed: Nov. 29, 2001

(51) Int. Cl. B32B 1/08; B29C 47/20

(52) U.S. Cl. 428/36.9; 264/141; 264/209.1

(57) ABSTRACT

A nanocomposite reinforced polymer and blends produced therefrom used for engineering and other purposes with mechanical properties such as stiffness, elasticity, tensile strength and lubricity which can be varied by metering the polymers and nanocomposite polymers prior to and during extrusion and by modifying the extrusion process by varying the parameters thereof including time, temperature and overall cool down time as well as controlling the draw down extrusion ratio, and the application in multilayer extrusion. The mechanical properties of the final resultant nanocomposite reinforced polymer blend can be accurately controlled by varying the mixing proportions with pure virgin polymers and copolymers. This unique process provides a method for customizing the mechanical properties of a nanocomposite reinforced polymer blend to specific target values which may exceed or be located between the mechanical properties values of the individual components of the resultant polymer blend.

### BACKGROUND OF THE INVENTION

1. Field of the Invention

The present invention is related to polymer nanocomposites and polymer blends and novel processing conditions to produce high precision tubing. This invention is directed primarily toward those medical applications such as catheters and balloons requiring improvements in many mechanical and other properties such as the balance between stiffness and flexibility, dimensional stability, and less tacky surfaces to decrease the tendency for the material to pick up dirt and other contaminants, and lubricity for ease of travel through the tube. Other applications include tubing in diagnostic equipment, conduits for wiring and any other tubing that might benefit from these improved attributes.

Polymer blends can be reinforced by many methods for the purposes of strengthening or stiffening or otherwise effecting the mechanical or other properties of thermoplastic polymers and polymer blends and the products that are extruded therefrom. The present invention deals specifically with polymers and polymer blends which are reinforced utilizing nanocomposite polymers mixed with other polymers, most particularly, with pure virgin block copolymers in such a manner that the mechanical properties can be pre-specified. This method of forming such a nanocomposite reinforced polymer blend is particularly useful in the field of intravenous and guiding catheters. Also the resultant nanocomposite reinforced polymer blend can be produced in the form of pellets which can be used for forming any polymer product such as desired and in order to facilitate pellet blends. The present invention is particularly useful with the class of Nylon polymers such as Nylon 12, Nylon 11 and Nylon 6.

2. Description of the Prior Art

The present invention deals with the analysis of the mechanical and other properties of polymer composites and polymer blends and, in particular, such polymers and polymer blends which are reinforced by an added component. Numerous patents have been granted in this field particularly including the use of nanoparticles for strengthening polymers and copolymers and the use of polymer blends such as shown in U.S. Pat. No. 4,472,538 patented Sep. 18, 1984 to O. Kamigaito et al and assigned to Kabushiki Kaisha Toyota Chuo Kenkyusho on a “Composite Material Composed Of Clay Mineral And Organic High Polymer And Method For Producing The Same”; and U.S. Pat. No. 4,810,734 patented Mar. 7, 1989 to M. Kawasumi et al and assigned to Kabushiki Kaisha Toyota Chuo Kenkyusho on a “Process For Producing Composite Material”; and U.S. Pat. No. 5,068,289 patented Nov. 26, 1991 to E. George et al and assigned to Shell Oil Company on a “Reinforced Polymer Compositions”; and U.S. Pat. No. 5,385,776 patented Jan. 31, 1995 to M. Maxfield et al and assigned to AlliedSignal Inc. on “Nanocomposites Of Gamma Phase Polymers Containing Inorganic Particulate Material”; and U.S. Pat. No. 5,554,120 patented Sep. 10, 1996 to Z. Chen et al and assigned to Advanced Cardiovascular Systems, Inc. on “Polymer Blends For Use In Making Medical Devices Including Catheters And Balloons For Dilatation Catheters”; and U.S. Pat. No. 5,556,383 patented Sep. 17, 1996 to L. Wang et al and assigned to Scimed Lifesystems, Inc. on “Block Copolymer Elastomer Catheter Balloons”; and U.S. Pat. No. 5,565,523 patented Oct. 15, 1996 to Z. Chen et al and assigned to Advanced Cardiovascular Systems, Inc. on “Polymer Blends For Use In Making Medical Devices Including Catheters And Balloons For Dilatation Catheters”; and U.S. Pat. No. 5,578,672 patented Nov. 26, 1996 to G. Beall et al and assigned to Amcol International Corporation on an “Intercalates; Exfoliates; Process For Manufacturing Intercalates And Exfoliates And Composite Materials Containing Same”; and U.S. Pat. No. 5,698,624 patented Dec. 16, 1997 to G. Beall et al and assigned to AMCOL International Corporation on an “Exfoliated Layered Materials And Nanocomposites Comprising Matrix Polymers And Said Exfoliated Layered Materials Formed With Water-Insoluble Oligomers And Polymers”; and U.S. Pat. No. 5,747,560 patented May 5, 1998 to B. Christiani et al and assigned to AlliedSignal Inc. on a “Melt Process Formation Of Polymer Nanocomposite Of Exfoliated Layered Material”; and U.S. Pat. No. 5,747,591 patented May 5, 1998 to Z. Chen et al and assigned to Advanced Cardiovascular Systems, Inc. on “Polymer blends For Use In Making Medical Devices Including Catheters And Balloons For Dilation Catheters”; and U.S. Pat. No. 5,830,182 patented Nov. 3, 1998 to L. Wang et al and assigned to Scimed Life Systems, Inc. on “Block Copolymer Elastomer Catheter Balloons”; and U.S. Pat. No. 5,877,248 patented Mar. 2, 1999 to G. Beall et al and assigned to Amcol International Corporation on “Intercalates And Exfoliates Formed With Oligomers And Polymers And Composite Materials Containing Same”; and U.S. Pat. No. 5,880,197 patented Mar. 9, 1999 to G. Beall et al and assigned to AMCOL International Corporation on “Intercalates And Exfoliates Formed With Monomeric Amines And Amides; Composite Materials Containing Same And Methods Of Modifying Rheology Therewith”; and U.S. Pat. No. 5,951,941 patented Sep. 14, 1999 to L. Wang et al and assigned to Scimed Life Systems, Inc. on “Block Copolymer Elastomer Catheter Balloons”; and U.S. Pat. No. 6,010,521 patented Jan. 4, 2000 to J. Lee et al and assigned to Advanced Cardiovascular Systems, Inc. on a “Catheter Member With Bondable Layer”; and U.S. Pat. No. 6,013,728 patented Jan. 11, 2000 to Z. Chen et al and assigned to Advanced Cardiovascular Systems, Inc. on “Polymer Blends For Use In Making Medical Devices Including Catheters And Balloons For Dilatation Catheters”; and U.S. Pat. No. 6,060,549 patented May 9, 2000 to D. Li et al and assigned to Exxon Chemical Patents, Inc. on “Rubber Toughened Thermoplastic Resin Nano Composites”; and U.S. Pat. No. 6,200,290 patented Mar. 13, 2001 to R. Burgmeier and assigned to Schneider (USA) Inc. on “Dilatation Balloons Containing Polyesteretheramide Copolymer”; and U.S. Pat. No. 6,210,396 patented Apr. 3, 2001 to S. MacDonald et al and assigned to Medtronic, Inc. on a “Guiding Catheter With Tungsten Loaded Band”; and U.S. Pat. No. 6,217,547 patented Apr. 17, 2001 to J. Lee and assigned to Advanced Cardiovascular Systems, Inc. on a “Lubricous And Readily Bondable Catheter Shaft”; and U.S. Pat. No. 6,271,298 patented Aug. 7, 2001 to C. Powell and assigned to Southern Clay Products, Inc. on a “Process For Treating Smectite Clays To Facilitate Exfoliation”.

### SUMMARY OF THE INVENTION

The nanocomposite reinforced polymers and polymer blends of the present invention are preferably used for the purpose of being extruded into a tube shape having an inside diameter ranging from 0.001 inches to 0.500 inches. Such tubes are commonly utilized for intravenous catheters and balloons for the purposes of maintaining open blood flow paths in the human blood circulation system as well as other medical purposes. Such tubes are also useful in analytical equipment, business equipment, aerospace and automotive applications.

The reinforced polymer of the present invention preferably has reinforcement characteristics enhanced by the addition thereto of an engineering nanoparticle producing a nanocomposite polymer. The pure virgin copolymer with which the nanocomposite polymer is mixed preferably comprises a copolymerized plastic material which is formed from the reaction of at least two component polymers in order to provide the final resultant reinforced polymer blend in such a manner that it displays mechanical properties attributable at least in part to each of the individual components of the polymers. These predictable mechanical properties can be of any value either between the similar properties of the two component polymers or exceeding the values of either one individually. Also shown are novel results for nanocomposites prepared solely from the pure virgin block copolymer. Lastly, nanocomposite polymers blended with other nanocomposite polymers exhibited a similar property trend as detailed above.

Common chemical construction between the pure virgin copolymer and the polymer in the nanocomposite polymer often yielded mechanical properties greater than either polymer component individually. Such common chemical construction is often attributable to the sharing of a common chemical segment and/or matrix. Another common element preferred between the nanocomposite polymer and the pure copolymer with which it is mixed is that both polymers exhibit similar crystalline chemical form. It should be obvious to appreciate that the pure virgin copolymer could be substituted with a pure virgin polymer and that these terms are herein used interchangeably.

One of the important characteristics of the present invention is that the amount of pure virgin copolymer added to the nanocomposite polymer can be metered or in some manner accurately controlled in order to produce a final resultant reinforced polymer blend which has specific values for certain mechanical or other properties such as stability, elasticity or lubricity.

The polymers with which the present invention are usable extend across the entire range of polymers but the most useful specific polymers have been found to be Nylon-based such as Nylon 6, Nylon 11 and in particular Nylon 12.

With the metering, as above described, of the pure virgin polymer or another nanocomposite polymer at specific percentages when it is extruded with the nanocomposite polymer, normally the mechanical properties will assume an intermediate value which is often directly proportional at an intermediate value between the mechanical property value for the nanocomposite polymer and the mechanical value for the pure virgin copolymer. This relationship sometimes will be a direct proportional relationship and at other times it may be inversely proportional or it may be indirectly proportional or unrelated. Sometimes the mechanical or other properties of the blended material may actually exceed the same parameters for the individual components of the blend.

The nanocomposite polymer blend may be simply a pellet blend followed by extrusion or the blend may be pre-extruded by any common melt compounding method referred to as a precompounded blend.

However, the important consideration is that the value for this specific mechanical property is predictable since it is based upon the mixing percentage between the nanocomposite polymer and the pure virgin copolymer and the process of extrusion. Either the nanocomposite polymer or the pure virgin polymer can be metered in volume in order to achieve a final overall ratio which will predict the mechanical properties of the resultant reinforced polymer blend formed therefrom. The particular mechanical properties which may be effected are many but may include stiffness, dimensional stability, lubricity, ductility or flexibility.

It is also within the contemplation of this present invention to form a multilayer tube extrusion where as many as five individual extruders are operated in tandem to produce a continuous tube with layers of targeted physical attributes for producing a fully functional final product.

The nanocomposite polymer may be a polyamide-based material or a polyester based material or other nylon based materials. The final resultant material may be transparent, opaque or translucent at various percentages between pure transparency and a fully opaque material.

The mechanical properties of the resultant reinforced polymer blend can also be controlled by the method of extrusion. One of the primary ways of modifying the mechanical properties, such as stiffness of the polymer blend, is by controlling the cooling environment such as by varying the cooling time or the cooling media. The cooling environment can be modified by increasing the temperatures in the cooling area to as much as 200 degrees Fahrenheit and the cooling time can be decreased by the lowering of the cooling temperature to as much as 32 degrees Fahrenheit by introducing thermal transfer media into the cooling environment. The thermal transfer media has a tendency to cool the resultant polymer blended product more homogeneously thereby providing a more ductile and dimensionally stable final product.

It has also been determined that a polymer reinforced with nanocomposite particles has a tendency to increase the adherence of ink to the external surface thereof which greatly enhances the ability to print indicia or other required markings on the exterior of the product.

It is an object of the nanocomposite reinforced polymer or nanocomposite reinforced polymer blend of the present invention to be particularly usable in forming of tubing having an inside diameter of 0.001 inches to 0.500 inches.

It is an object of the nanocomposite reinforced polymer blend of the present invention to produce a resultant reinforced polymer blend which is extruded from a nanocomposite polymer and a pure virgin polymer.

It is an object of the nanocomposite reinforced polymer blend of the present invention which produces tubing particulary usable for forming of an intravenous catheter as well as guiding catheters.

It is an object of the nanocomposite reinforced polymer or nanocomposite reinforced polymer blend of the present invention to produce multilayer tubing particularly usable for forming of an intravenous or guiding catheter.

It is an object of the nanocomposite reinforced polymer blend of the present invention to produce a continuous multidurometer tube where the materials with the different durometer attributes exhibit the same melting point usable in a wide range of catheter applications.

It is an object of the nanocomposite reinforced polymer blend of the present invention wherein a nanocomposite polymer is mixed with a pure virgin copolymer which comprises a blended plastic material formed from reacting two separate component polymers in order to provide the reinforced polymer blend having mechanical properties which are in some manner attributable to each of the individual component polymers.

It is an object of the nanocomposite reinforced polymer blend of the present invention to mix a nanocomposite polymer with a pure virgin copolymer wherein the polymer portion of each construction can share common chemical segments, matrix and preferably have the same crystalline chemical form.

It is an object of the nanocomposite reinforced polymer blend of the present invention to mix a nanocomposite polymer with a second nanocomposite polymer.

It is an object of the nanocomposite reinforced polymer blend of the present invention wherein the amount of pure virgin copolymer added to the nanocomposite polymer can be metered to vary the mechanical properties of the resulting reinforced polymer blend.

It is an object of the nanocomposite reinforced polymer blend of the present invention wherein the amount of pure virgin copolymer can be precompounded with the nanocomposite polymer to vary mechanical properties of the resulting reinforced polymer blend.

It is an object of the nanocomposite reinforced polymer blend of the present invention wherein the mechanical properties of the resulting reinforced polymer blend can be predicted by varying the amount of pure virgin copolymer added to a pre-specified amount of nanocomposite polymer.

It is an object of the nanocomposite reinforced polymer blend of the present invention wherein one or both of the polymer based products are nylon based.

It is an object of the nanocomposite reinforced polymer blend of the present invention wherein Nylon 6, Nylon 11 and Nylon 12 are commonly used as polymer components.

It is an object of the nanocomposite reinforced polymer blend of the present invention wherein various mechanical properties such as stiffness, dimensional stability, lubricity, ductility and flexibility can be controlled by varying the mixture percentages between nanocomposite polymers and pure virgin copolymers.

It is an object of the nanocomposite reinforced polymer blend of the present invention wherein mechanical properties can be controlled with a method of extrusion wherein the cool down temperature of the extruded product can be varied.

It is an object of the nanocomposite reinforced polymer blend of the present invention wherein the final resultant nanocomposite polymer blend can be formed into pellets.

It is an object of the nanocomposite reinforced polymer blend of the present invention wherein the final properties can be controlled by the stiffness of the virgin block copolymer as well as by the concentration thereof.

It is an object of the nanocomposite reinforced polymer blend of the present invention wherein the reinforced nanocomposite polymer blend can be a polyamide-based thermoplastic nanocomposite.

It is an object of the nanocomposite reinforced polymer blend of the present invention wherein the pure virgin thermoplastic copolymer can be a polyether block amide.

It is an object of the nanocomposite reinforced polymer blend of the present invention wherein the pure virgin thermoplastic copolymer can be a polyether block ester.

DEFINITION OF TERMS

| | |
|---|---|
| Nylon 6 Nano = | Nylon 6 blended with 2% nanoparticles. |
| Nylon 12 = | Nylon 12 |
| Nylon 12 Nano = | Nylon 12 blended with 5% nanoparticles |
| Nylon6/7233 Pebax = | 50/50 blend of Nylon 6 with Pebax 7233 |
| | having 1% nanoparticles |
| 7233 Nano = | Pebax 7233 with 5% nanoparticles |
| 7233 = | Pebax 7233 |
| Nylon12 Nano/7233 = | 50/50 blend of Nylon 12 nanocomposite |
| | material with Pebax 7233 (which contains |
| | 2.5% nanoparticles) |

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1 is a graph of modulus versus toughness for various polymers and nanocomposite polymers wherein modulus is shown in pounds per square inch and toughness is shown as a multiplicative combination of tensile strength and elongation capability;

FIG. 2 is a chart showing the effect of the addition of nanoparticles to a Nylon polymer used to make tubing evaluating basic mechanical properties and secondary mechanical properties such as surface properties as well as barrier properties thereof;

FIG. 3 shows test data illustrating the increase in stiffness and ductility by the addition of nanoparticles to Nylon 12 and Pebax 7233 used on injection molded tensile bars;

FIG. 4 is an illustration of the increase in stiffness and ductility with simultaneously increased dimensional stability and improved surface characteristics for tubing used in catheters by the addition of nanoparticles to Nylon 12 and Pebax 7233 where the blends were prepared by simple pellet blending prior to tube extrusion;

FIG. 5 shows the addition of nanoparticles to Nylon 11 and Pebax 2533 for catheter tubing which illustrates that Nylon 11 has a higher melting point than Nylon 12 and Pebax 2533 is extremely soft but readily accepts filler nanocomposite material accompanied by improved dimensional stability and dirt retention characteristics where the blends were prepared by simple pellet blending prior to tube extrusion;

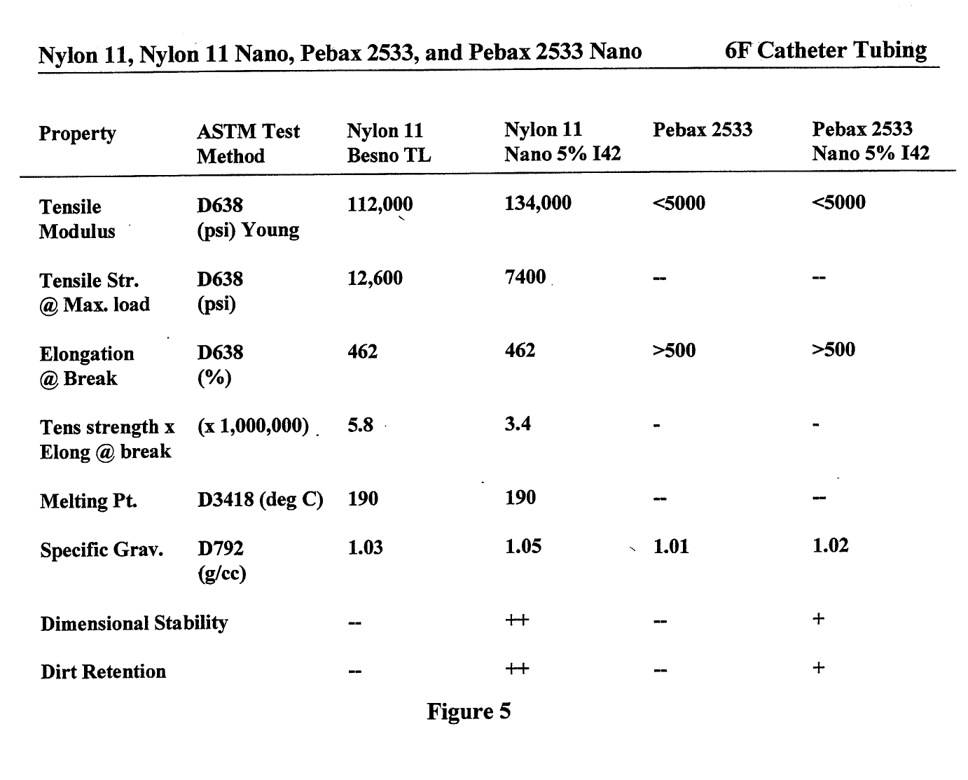

FIG. 6 shows test results from polymers based on Nylon 12 and Pebax 7233 illustrating the formation of blends for achieving unique property balances where the blends are 50/50 pellet blends of Nylon 12 Nanocomposite and Pebax 7233 virgin copolymer and then compared to neat Pebax 7233 and nanocomposite polymers;

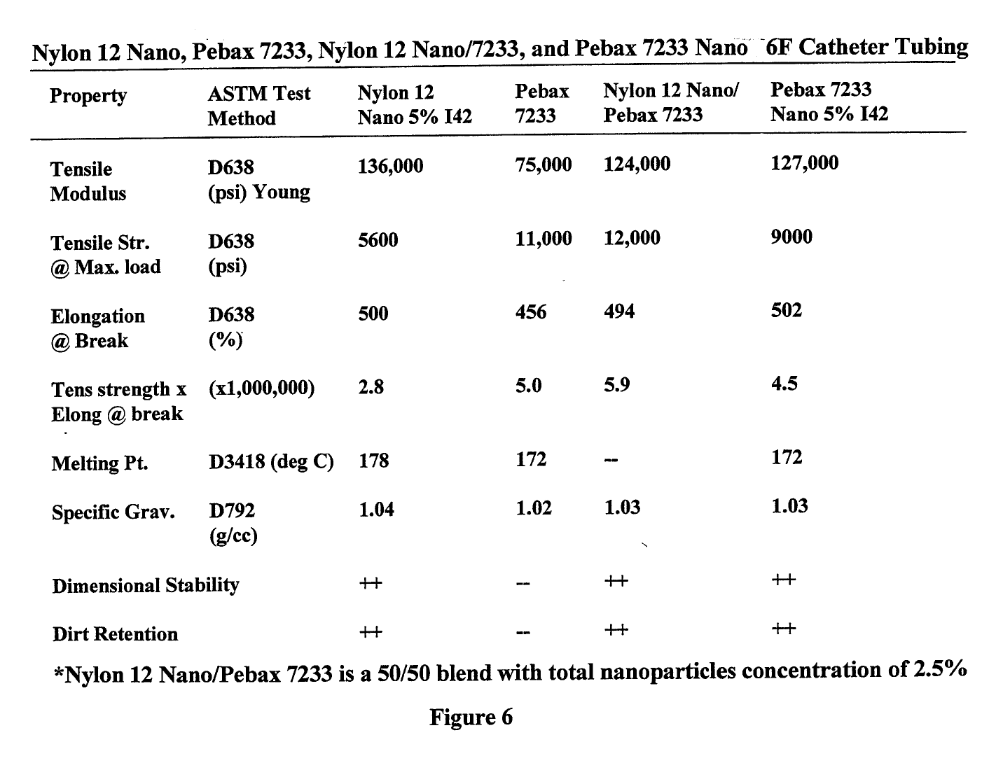

FIG. 7 shows various polymer materials reinforced with nanoparticles which illustrate unique property balances showing that Nylon 12 is superior to Nylon 11 nanocomposite when blended with Pebax 7233 and made for the purposes of catheter tubing where the blends were prepared by simple pellet blending prior to tube extrusion; and

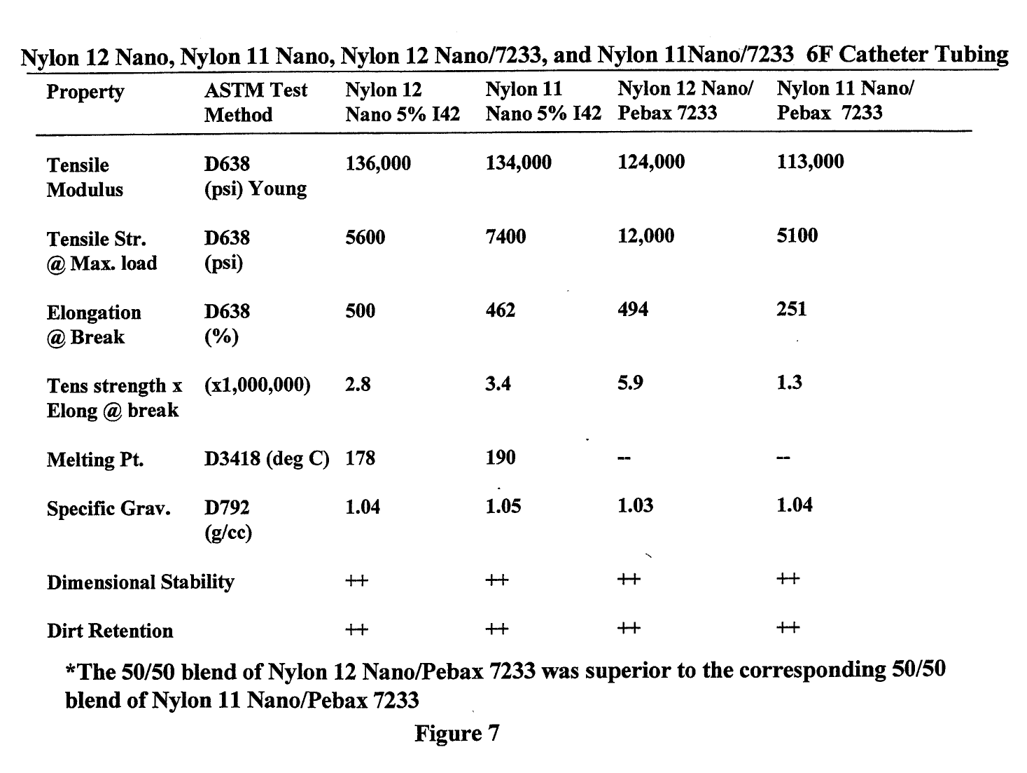

FIG. 8 shows various nanocomposite polymers based on Nylon 6 and Nylon 12 which display unique property balances and illustrate that Nylon 6 can provide a higher modulus for the purpose of forming intravenous catheters, guiding catheters and balloon tubing where the blends were prepared by simple pellet blending prior to tube extrusion, and it illustrates how modulus can be controlled by the type of virgin copolymer employed, such as use of Pebax 7233 versus Pebax 2533 added to Nylon 6 based nanocomposite

### DETAILED DESCRIPTION OF THE PREFERRED EMBODIMENT

The present invention deals with the blending of various polymers and copolymers for the purposes of being able to accurately predict the various mechanical properties of such blends particularly when the blends include nanoparticles. Nanoparticles can be included in the blend at various final percentages ranging from 1% to as much as 20%. More commonly nanoparticles will be added between 1.0% and 7.0% to achieve attributes and mechanical characteristics in the final blend within specific value ranges.

The present invention includes but is not limited to Nylon 6, Nylon 11 and Nylon 12 nanocomposites, their blends with virgin block copolymers, and their blends with Nylon based nanocomposites, and also block copolymer nanocomposites to produce customized polymers having predetermined properties for a range of various applications. The scope of use of the reinforced copolymers made in accordance with this invention extends to several aspects of Percutaneous Transluminal Angioplasty. This field includes novel guide catheter design considerations and novel balloon materials. The polymers produced under the present invention can also be extended to any other tubing application including fine tubing used in diagnostics equipment, conduits for industrial wiring, and any other tubing applications requiring better dimensional stability, novel balances of mechanical properties, and improved surfaces with better lubricity and less affinity for dirt.

Generally a nanocomposite is defined as a near molecular blend of polymer molecules and nanoscale particles. These nanoscale particles, usually referred to as nanoparticles, normally are platelets wherein the thickness thereof is on the order of nanoscale dimensions. The term “composite” implies that there is a true chemical adhesion between the platelets and the polymer matrix and that the platelets are dispersed. These conditions lead to improved mechanical properties when compared to the pure or block copolymer material. The nanocomposite polymer blend of this invention is most useful in that it provides enhanced mechanical properties when compared with the nanocomposite polymer. The polymer matrix of the nanocomposite polymer is compatible with the pure added copolymer thereby not sacrificing one mechanical or other property in exchange for another, but allowing for significant increase in one or both such as mechanical or other properties.

Nylons were developed in the 1930's at DuPont. They are generally characterized under the trade names Nylon 6, Nylon 11 and Nylon 12 and are polyamide materials characterized by the number of the carbon atoms between amide groups. Typically those amide groups having carbon atoms less in number will have higher melting points and be more sensitive to moisture.

One of the primary characteristics of the present invention is in the unique ability to provide a custom polyamide product line to customers which enables customers to request tubing produced with specific targeted hardness with corresponding tensile modulus ratings as desired but normally falling between 1000 pounds per square inch to 300,000 pounds per square inch and Shore D durometer readings of from 25 to 90. The novel method and composite technology of the present invention enables one to provide tubing at higher durometer readings without the loss of toughness normally associated with materials of such characteristic especially in Nylon based system.

The traditional line of Nylon homopolymers are readily available such as Nylon 6, Nylon 12 and Nylon 11 but also a full line of Nylon/Polyether copolymers are available commercially known as Pebax. Pebax is a commercial term for a pure virgin copolymer that combines Nylon and polyether. These such thermoplastic hybrids exhibit a balance of properties between Nylon 12 and the elastomers such that they have become widely commercially used. These type of materials are often referred to as thermoplastic elastomers or block copolymers. The present invention provides a means for combining of nanocomposite reinforced polymers with pure Nylon based materials for the purpose of yielding mechanical and other property balances that are new and unexpected while also being uniquely predictable.

The improved manufacturing process and composite blend technology of the present invention allows a full line of Nylon based systems with the added ability to exceed current stiffness and flexibility balances as well as customize the durometer reading as desired by a client for a specific application or use. One particular very important area where such predictable stiffness and flexibility balances are required is in medical tubing used for guide catheters and balloons where the unique ability to form tubing for various applications is particularly desirable within narrow predefined ranges. Commercial polymer materials currently on the market for the purposes of forming intravenous catheters and balloons and other such medical equipment are often made from Pebax 7233 and various Nylon blends. In accordance with the present invention if you take any of the current materials and add a nanoparticle component thereto then you produce a material that has significantly enhanced tensile strength and toughness while at the same time maintaining high modulus values or resistance to denting or penetration thereof. This is achieved due to the addition of the nanoparticles to the polymer blend used for producing the tubing or other material.

One of the unique characteristics is in the ability of such polymers to combine in such a manner that, for example, you take Nylon 12 with 5% nanocomposite material and blend it in equal amounts with pure Pebax 7233. The final resultant material has greatly increased toughness without any significant change in the modulus characteristics. The significant increase in toughness is far greater than the toughness of either individual material, that is, namely the pure Pebax 7233 or the Nylon 12 5% nanocomposite. This synergy is achieved because of the common chemical structure of the basic polymer components of the Nylon 12 nanocomposite material and the Pebax 7233. Thus you can actually maintain the modulus values of the resultant polymer material while simultaneously significantly increasing the material toughness after performing a blending step which actually reduces the nanoparticles percentage of the resultant material. It is also within the scope of the present invention to start with a nanocomposite polymer containing 1% to 20% of nanoparticles.

Many of the commercial tubings currently used for catheters and other applications is composed partly or completely of one of the Pebax formulations which basically comprise block copolymers made of a polyether in combination with Nylon polymers such as Nylon 12. These two materials are reacted in various proportions with Nylon providing the stiffening component and polyether being the more soft material. Various mixtures at various percentages can adjust the stiffness to some value between the value for Pebax 2533 and Nylon 12. Thus the hardest material is Nylon 12 and softer material is Pebax 7233 and then even softer material is Pebax 4233 and, finally, the softest material is Pebax 2533. Thus, with these materials, the hardest material you can form is Nylon 12.

However, under the present invention, nanocomposite material is introduced to form an entirely new range of materials even harder than Nylon 12. This new material can now be utilized for tubing in medical applications not possible heretofore because of the increased toughness now possible. This is particularly useful in intravenous catheter tubing and balloon medical applications. Such devices are usable with balloon catheters, guide catheters or any other catheter or balloon-type intravenous medical devices where control of stiffness, flexibility and surface lubricity is extremely important.

A typical structure of a guide catheter consists of an inner fluoropolymer layer, a middle layer comprised of a metal mesh and the outer layer of a Nylon-based materials that can be pieced together to provide different flexibility and stiffness along the length of the tube.

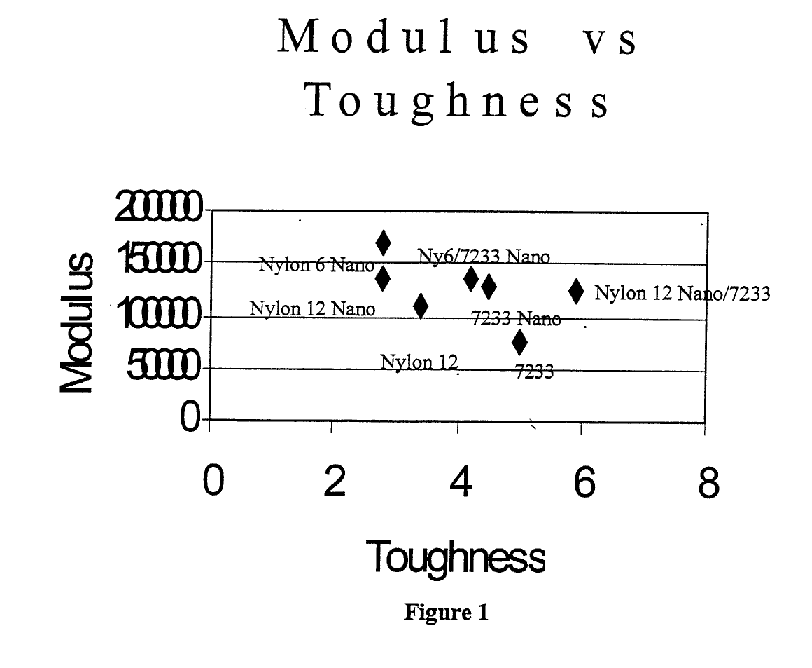

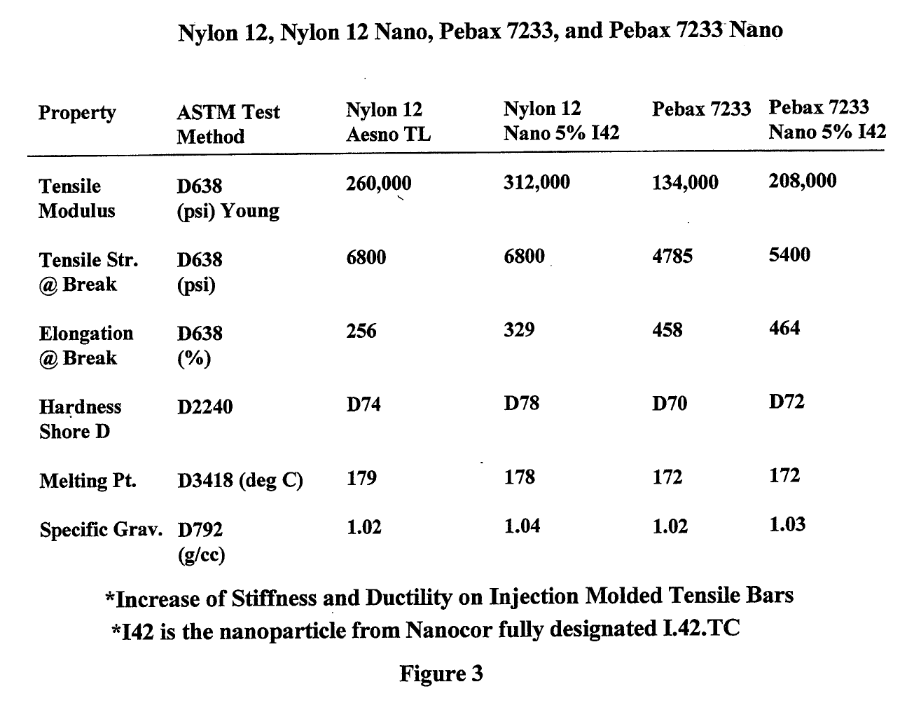

FIG. 3 shows stiffness and ductility increasing when polymers are reinforced with nanoparticles for making injection molded parts. This is illustrated only to show this capability can be extended beyond only use for tubing such as catheter tubing. We see from FIG. 1 that where you mix nanocomposite polymers with other polymers, you can get enhanced mechanical properties from extruded parts.

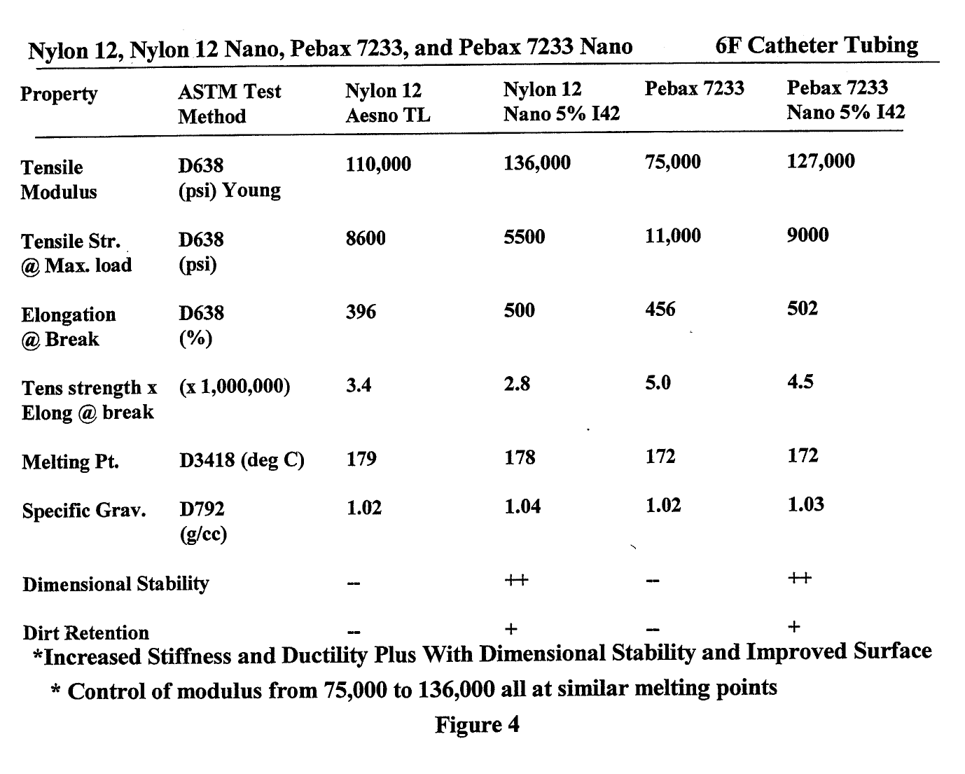

FIG. 4 shows the numerical test results first taken on catheter tubing rather than injection molded tensile bars. The catheter tubing is extruded and produces results much closer to those which will be used in accordance with the material of the present invention. This table generally shows that the multiplicative combination of the tensile strength and the elongation of break which gives toughness is fairly constant. In other words when the elongation value went up, the tensile strength tended to be lowered but in the terms of overall toughness the multiplicative combination of the two remains fairly constant.

The present invention provides a novel manner of combining a known nanocomposite polymer blend with another polymer or copolymer being of the same family or matrix as was used to make the nanocomposite polymer to yield a resulting material that has directly predictable mechanical properties which may be between the properties of the nanocomposite polymer and the polymers with which it is added or may be entirely outside the range of the same mechanical properties for the two original materials, namely the nanocomposite polymer or the pure polymer.

A block copolymer otherwise known as a neat or pure virgin copolymer can be defined as a custom synthesized plastic which combines the attributes of two different polymers. These polymers tend to exhibit a standard range of solvent resistance and modulus/ductility balance. Other polymers, however, are very flexible but lack the required mechanical properties such as strength or stiffness. Block copolymer technology will allow a device designer to choose various different balances between stiffness and flexibility in order to custom design for a particular use. For example, combining the attributes of stiff Nylon polymers with the more flexible polyether polymers has resulted in a family of block copolymers known as polyether block amides sold commercially as Pebax which was defined above. The importance of tailoring of polymer properties such that the resultant material can have accurate and predictable characteristics is an extremely important aspect of the present invention. This tailoring of the properties of the polymer can also be controlled by the orientation of the polymer during extrusion or by other activities such as controlling the rate at which the material is cooled after processing. The rate of cooling after processing can be controlled by the environment within which the cooling occurs.

Another item that can be varied to control the properties of the polymers is in choosing the original polymer within specific molecular weight limits. For example polyethylene terephthalate can be made into fibers for various apparel, for transparent liquid containers, for heat shrink tubing used in light bulb covers or, most particularly, for balloons used for medical angioplasty. Generally, higher molecular weight materials tend to be more suitable for extrusion and lower molecular weight materials are more suitable for injection molding.

The block copolymers of crystallized polyesters like PET and PBT with flexible polyethers yield a family of materials known as polyester block ethers that are commonly known as Hytrel and Arnitel.

Such polymers are particularly customized for specific applications commonly by melt compounding with other polymers or with opaque fillers having color pigments. More recently, however, nanoparticles have been added to achieve novel physical characteristics not achievable heretofore. Compounds used for parts of catheters which are extruded in the medical industry are often made from blends of Nylon 12, Pebax, bismuth trioxide and, by convention, often an orange, or other color, pigment. The present invention provides a means for predicting the physical properties of blends containing these ingredients and other similar ingredients.

Bismuth trioxide is a high density filler designed to make the tubing radiopaque. Other radiopaque fillers include high density fillers based on tungsten and barium.

With the method and compositions disclosed in the present invention, the properties of the materials can be tailored by a preliminary balancing of formulation and fabrication techniques in such a manner as to provide specific characteristics in the resultant final polymer. Unique processing, multi-layer extrusion, as well as the science of block copolymers, and the use of nanocomposites, will provide a means for achieving polymer blends with predictable mechanical or other properties falling within specific limits to satisfy custom application requirements.

Also a Nylon 6 based nanocomposite was blended in various proportions with a Pebax 7233 and Nylon 12 based nanocomposite to tailor final tubing properties.

Thereafter blends of Nylon 6 nanocomposite were made with virgin Pebax 7233 and Pebax 2533. The Nylon 6 nanocomposite blended with the Pebax 7233 was extruded into cooling media. The blend tended to run more stable than the pure Nylon nanocomposite. It was also observed that the modulus was between the two individual blended components but was closer in ductility to the pure Pebax 7233. The Nylon 6 nanocomposite blended with the Pebax 2533 was extruded into cooling media and displayed very ductile and strong characteristics with a modulus which was higher than the virgin Pebax 7233. Blends with Pebax 2533 were more opaque than blends with Pebax 7233.

The Nylon 11 nanocomposite which was blended with the Pebax 7233 produced a resultant polymer having intermediate stiffness. However, it was less ductile than either of the two individual blend components. It was determined that the 50/50 blend was inferior to the blend of Nylon 12 and Pebax 7233. This was a genuinely unexpected result.

A Nylon 12 control was utilized with a Nylon 12 nanocomposite containing 5% nanomer which were both extruded into cooling media. The Nylon 12 nanocomposite was more stiff and maintained a higher elongation characteristic. A 50/50 pellet blend was formed of Nylon 12 nanocomposite and Pebax 7233 mixed in equal amounts and extruded. The 50/50 blend exhibited a superior balance of overall mechanical properties. It was particularly noted that the 50/50 blend was superior to the Nylon 11 and Nylon 6 blends with the virgin Pebax 7233.

A key aspect of the present invention concerns the process by which the nanoparticles of the Nylon/Pebax nanocomposite were preferably located in the amide phase of the copolymer blend. This process would increase the stiffness of the Nylon phase while leaving the polyether phase filler free to provide ductility in the system. This unique combination provides an unusual balance of stiffness and flexibility. During our testing, it was noted that the nanocomposites of Nylon 11, Nylon 12 and Pebax 7233 all were more dimensionally stable and had more lubricity than their analogous material without nanoparticles. Both the Pebax 2533 nanocomposite and the virgin Pebax 2533 had low modulus and high ductility. Such flexibility could be found to be useful for future medical applications where a catheter may be taken to arteriole sights in the brain by blood flow.

It was also particularly noted that whenever Pebax 7233 nanocomposite was run into low temperature cooling media, it caused warping of the tube as opposed to the same material which showed reduced warping characteristics when extruded into an ambient cooling media. When running samples for actual applications we noted that the resultant polymer material had unusually high elongation or flexibility without sacrificing material modulus or rigidity. A Pebax 7233 control was tested versus a Pebax 7233 nanocomposite 5% mixture and it was noted that the nanocomposite tube tended to be much straighter, did not pick up as much dust and was much stiffer without any loss in elongation to break characteristics.

FIG. 1 shows modulus versus toughness values for tubing extruded into ambient cooling media. Toughness, the abscissa coordinate, is computed by multiplying tensile strength by elongation to break and this is the abscissa. The ordinate in this chart is modulus measured in pounds per square inch. The various pure polymers and nanocomposites are shown which clearly shows that the nanocomposites have higher modulus, and for the nanocomposite blends with Pebax 7233 higher toughness than the corresponding polymer without nanoparticles.

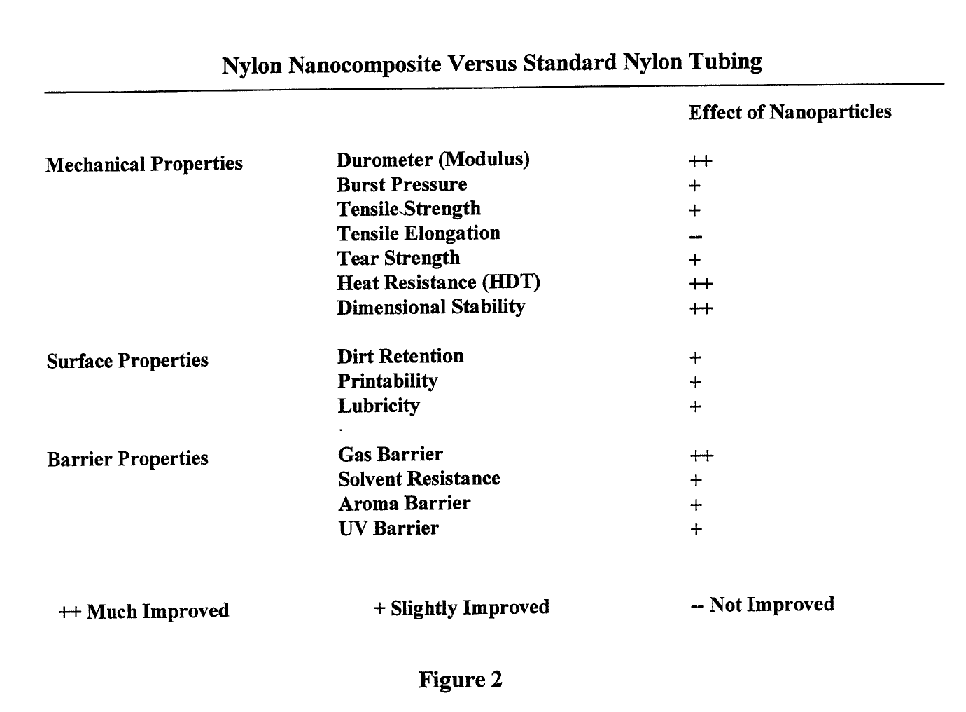

FIG. 2 shows the general characteristics of various mechanical properties or auxiliary mechanical properties such as service properties or barrier properties resulting from the addition of nanoparticles to the overall polymer. For example the modulus or durometer reading is shown to significantly increase as well as the heat resistance and dimensional stability as compared to the basic Nylon. However, there was only a marginal increase in the Nylon composite versus the pure Nylon material when evaluating burst pressure, tensile strength and tear strength and there was no change measured in the tensile elongation characteristic.

The other mechanical properties more commonly referred to as surface properties and barrier properties all showed increases in measurements resulting from the addition of nanocomposite nanoparticles. The gas barrier properties of the material was greatly increased by the use of nanoparticles to the base Nylon material whereas all other surface properties and barrier properties were only marginally increased and they are namely, dirt retention, printability, lubricity, solvent resistance, aroma barrier characteristics and ultraviolet barrier characteristics. All the tests resulting in characterizing property differences shown in FIG. 2 were as a result of comparing a Nylon tubing with Nylon nanocomposite tubing.

In practice the method and materials of the present invention would be formed by taking, for example, a standard fairly stiff polymer such as Nylon 12 and combining it with a percentage of nanoparticles of from 20% down to a trace level. Most usually, however, the percentage would be in the 2% to 10% range. This nanocomposite reinforced Nylon 12 polymer blend would then be the base hardest material necessary for customized applications. It could be mixed with pure virgin block copolymers or virgin polymers in any relative percentage in order to define a resultant final polymer material having mechanical properties of a value between the values thereof, that is somewhere between the given mechanical property for Nylon 12 or for the nanocomposite reinforced Nylon 12. Thus, merely by the introduction of nanoparticles, it becomes possible to form a polymer material harder than the base polymer, in this case Nylon 12, while at the same time providing the capability to predetermine the exact value of the mechanical property for the resultant final polymer blend by mixing a pre-specified percentage of, for example, nanocomposite reinforced Nylon 12 blend with the pure virgin block copolymer Pebax 7233 or virgin polymer Nylon 12. Thus, a greater range of values for the particular mechanical property are capable of being chosen for the final product but also that value is entirely predictable by varying the predefined percentage of blending between, for example, the nanocomposite reinforced Nylon 12 polymer and the pure virgin polymer such as Nylon 12, itself. Another attribute of this approach is the ability to maintain a constant melting point at different durometer levels.

The same possibility is available with other polymers or copolymers such as Pebax 7233, 4233 or 2533. These are commonly available copolymers which are Nylon based which can be mixed with nanocomposites to increase the toughness thereof while having minimal effect on the modulus. The nanocomposite reinforced Pebax polymer material can then be mixed with pure virgin Pebax material to assume any mechanical property between those two values and also surely to assume toughness values greater than is possible with the pure Pebax virgin polymer. It has also been determined that some copolymers provide new and unexpected values for mechanical properties such as toughness. As described above, the data in FIG. 1 shows that when you blend a Nylon 12 Nanocomposite reinforced polymer with Pebax 7233, the resultant blend has a toughness greater than either component individually. The Nanocomposite reinforced Nylon 12 polymers yielded a toughness rating of approximately 2.8 and the Pebax 7233 yielded a toughness rating of approximately 4.9, however the polymer blend of these two materials yielded a toughness of almost 6. Here toughness is calibrated as a multiplicative combination of tensile strength and elongation to break parameters.

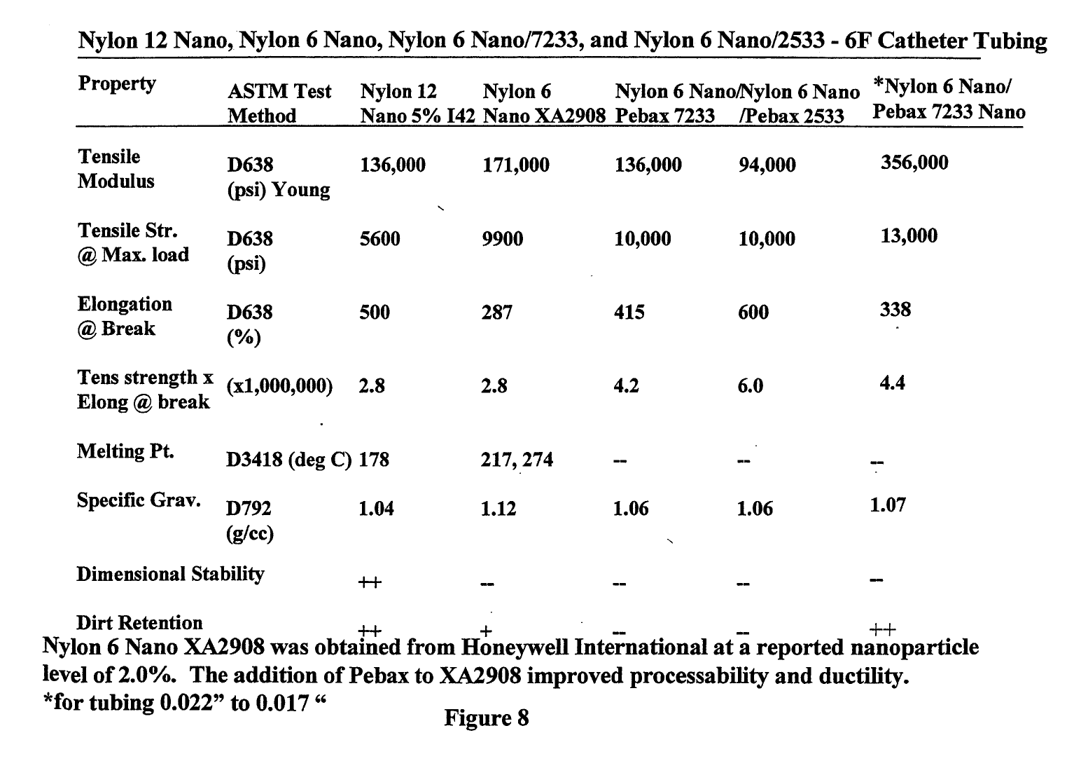

On the other hand Nylon 6 nanocomposite reinforced material is shown in FIG. 1 yielding approximately a 2.8 toughness value and Pebax 7233 shows a toughness rating of approximately 4.9 whereas the blend formed of these two materials shown as Nylon/7233 Nano shows a toughness of approximately 4.2. The toughness rating is approximately the expected toughness rating resulting from the blending of these two components since it is located between their individual toughness ratings. Additionally, Nylon 6 nanocomposite was blended with Pebax 7233 nanocomposite in a thin wall tubing to yield modulus values in excess of 300,000 psi and a toughness rating of 4.4. See the last column of FIG. 8.

However, the toughness rating for the 50/50 blend of Nanocomposite reinforced Nylon 12 and the Pebax 7233 is far greater that either individual component. Thus, the present invention provided a means for predicting the heretofore unpredictable mechanical properties of blending certain nanocomposite reinforced materials with certain block copolymers for use in specific applications having particular needs for mechanical properties of a given predetermined value. These enhanced mechanical properties are believed to be a result of the common chemical structure between the polymer of the nanocomposite reinforced material and the virgin block copolymer with which it is blended. If the polymers are similar in chemical segment then the resultant mechanical properties may indeed exceed either of the components, however, if the base polymers of the components are different then the resultant mechanical properties will be more predictably located intermediate between the values of the components, that is, between the values of the nanocomposite reinforced polymer blend and the virgin block copolymer.

It is also noted that upon blending the Nylon 12 nanocomposite with five percent nanoparticle with virgin Pebax 7233 that the final modulus is higher than expected for a material containing only 2.5% nanoparticles.

While particular embodiments of this invention have been described above and shown in the drawings, it will be apparent, that many changes may be made in the form, arrangement and positioning of the various elements of the combination. In consideration thereof it should be understood that preferred embodiments of this invention disclosed herein are intended to be illustrative only and not intended to limit the scope of the invention.

We claim:

1. A nanocomposite reinforced polymer extruded into a tube having 0.001 inches to 0.500 inches inside diameter for use in an intravenous catheter.

2. A reinforced polymer blend formed by extruding a nanocomposite polymer with a pure virgin copolymer into tubing having an inside diameter of 0.001 to 0.500 inches.

3. A reinforced polymer blend as defined in claim 2 wherein said nanocomposite polymer includes nanoparticles therein.

4. A reinforced polymer blend as defined in claim 2 wherein said pure virgin copolymer comprises a reacted plastic material formed from a mixture of at least two individual component polymers in order to provide the reinforced polymer blend with at least some mechanical properties attributable to each of said individual component polymers.

5. A reinforced polymer blend as defined in claim 2 wherein said nanocomposite polymer and said pure virgin copolymer share a common chemical segment and matrix.

6. A reinforced polymer blend as defined in claim 2 wherein said nanocomposite polymer and said pure virgin copolymer both are based upon thermoplastic polymers having the same crystalline chemical form.

7. A reinforced polymer blend as defined in claim 2 wherein said pure virgin copolymer is added to said nanocomposite polymer in metered amounts to predetermine the mechanical properties of the resultant reinforced polymer blend so formed.

8. A reinforced polymer blend as defined in claim 7 wherein said nanocomposite polymer and said pure virgin copolymer share a common chemical family and matrix to enhance predictability of the mechanical properties of the resultant reinforced polymer blend so formed.

9. A reinforced polymer blend as defined in claim 2 wherein said pure virgin copolymer includes Nylon and said nanocomposite polymer include Nylon.

10. A reinforced polymer blend as defined in claim 9 wherein said pure virgin copolymer includes Nylon 6 and said nanocomposite polymer includes Nylon 6.

11. A reinforced polymer blend as defined in claim 9 wherein said pure virgin copolymer includes Nylon 11 and said nanocomposite polymer includes Nylon 11.

12. A reinforced polymer blend as defined in claim 9 wherein said pure virgin copolymer includes Nylon 12 and said nanocomposite polymer includes Nylon 12.

13. A reinforced polymer blend as defined in claim 9 wherein a series of decreasing durometer blends are produced with similar melting points for advantages in forming composite guide catheters.

14. A reinforced polymer blend as defined in claim 7 wherein the mechanical properties of the resultant reinforced polymer blend are intermediate between the mechanical properties of the pure virgin copolymer and the nanocomposite polymer.

15. A reinforced polymer blend as defined in claim 8 wherein at least some of the mechanical properties of the resultant reinforced polymer blend are higher than the same mechanical properties of the pure virgin copolymer and the nanocomposite polymer.

16. A reinforced polymer blend as defined in claim 15 wherein the mechanical properties include stiffness.

17. A reinforced polymer blend as defined in claim 15 wherein the mechanical properties include dimensional stability.

18. A reinforced polymer blend as defined in claim 15 wherein the mechanical properties include outer surfaces with more lubricity with reduced tendency for dust contaminants to adhere thereto.

19. A reinforced polymer blend as defined in claim 15 wherein said mechanical properties include outer surfaces with enhanced lubricity for ease of catheter placement and movement.

20. A reinforced polymer blend as defined in claim 15 wherein the mechanical properties include ductility.

21. A reinforced polymer blend as defined in claim 2 wherein said pure virgin copolymer is nylon based.

22. A reinforced polymer blend as defined in claim 21 wherein said nanocomposite polymer is polyamide-based to form a resultant reinforced polymer blend which is also polyamide-based.

23. A reinforced polymer blend as defined in claim 21 wherein said nanocomposite polymer is polyester-based to form a resultant reinforced polymer blend which is also polyester-based.

24. A reinforced polymer blend as defined in claim 2 wherein said nanocomposite polymer includes 1% to 10% by weight of nanoparticles with Nylon 12 and wherein said pure virgin copolymer comprises Nylon 12.

25. A reinforced polymer blend as defined in claim 24 wherein said Nylon 12 pure virgin copolymer is added to said nanocomposite polymer in pre-specified amounts in order to predetermine hardness of the resultant reinforced polymer blend so formed.

26. A reinforced polymer blend as defined in claim 4 wherein the resultant reinforced polymer blend so formed is transparent.

27. A reinforced polymer blend as defined in claim 4 wherein the resultant reinforced polymer blend so formed is at least partially translucent.

28. A reinforced polymer blend as defined in claim 4 wherein the resultant reinforced polymer blend so formed is opaque.

29. A reinforced polymer blend as defined in claim 7 wherein the cooling down time for the resultant reinforced polymer blend is increased.

30. A reinforced polymer blend as defined in claim 7 wherein the resultant reinforced polymer blend is cooled down in a temperature controlled environment having an increased temperature in order to improve ductility and dimensional stability thereof.

31. A reinforced polymer blend as defined in claim 7 wherein the resultant reinforced polymer blend is cooled down in an ambient air environment.

32. A reinforced polymer blend as defined in claim 7 wherein the draw down ratio is increased to increase the final stiffness of the resultant reinforced polymer blended material.

33. A reinforced polymer blend as defined in claim 7 wherein the nanocomposite polymer increases the adherence of ink used for printing on the exterior of any product formed from the resultant nanocomposite reinforced polymer blend material.

34. A reinforced homopolymer nanocomposite material with prespecified strength parameters controlled by the metered amount of pure virgin copolymers added thereto wherein the pure virgin copolymers are similar chemically to the homopolymer in the reinforced homopolymer nanocomposite material.

35. A reinforced homopolymer nanocomposite material with prespecified strength parameters as defined in claim 34 wherein the resultant reinforced homopolymer nanocomposite materials is formed into pellets.

36. An intravenous catheter or part thereof formed from thermoplastic reinforced polymer tubing wherein the ductility thereof is controlled by the relative amount of pure virgin polymer extruded with a nanocomposite reinforced copolymer.

37. An intravenous catheter or part thereof formed from thermoplastic reinforced polymer tubing as defined in claim 36 wherein the flexibility of the intravenous catheter is further controllable by controlling the temperature of the pure virgin polymer and the nanocomposite reinforced copolymer during extrusion.

38. An intravenous catheter or part thereof formed from thermoplastic reinforced polymer tubing as defined in claim 36 wherein the flexibility is further controllable by multilayer extrusion.

39. A reinforced polymer blend formed by extruding a first nanocomposite polymer with a second nanocomposite polymer into tubing having an inside diameter of 0.001 to 0.500 inches.

40. A reinforced polymer blend as defined in claim 39 wherein said first nanocomposite polymer includes Nylon 6 and said second nanocomposite polymer includes a Pebax-based nanocomposite.

41. A reinforced polymer blend formed by extruding a nanocomposite polymer with a pure virgin copolymer into pellets.

42. A reinforced polymer blend formed by blending together a nanocomposite reinforced polymer and a virgin block copolymer to produce a resultant reinforced copolymer blend having a toughness greater than the toughness of the nanocomposite reinforced polymer and having a toughness greater than the toughness of the virgin block copolymer.

43. A reinforced polymer blend as defined in claim 42 wherein toughness is a mechanical property calculated as the product of tensile strength and elongation to break rating.

44. A reinforced polymer blend as defined in claim 42 wherein the virgin block copolymer comprises Nylon based.

45. A reinforced polymer blend as defined in claim 44 wherein the virgin block copolymer comprises Pebax 7233.

46. A reinforced polymer blend as defined in claim 44 wherein the virgin block copolymer comprises Pebax 2533.

47. A reinforced polymer blend as defined in claim 42 wherein the nanocomposite reinforced polymer is Nylon based.

48. A reinforced polymer blend as defined in claim 47 wherein the nanocomposite reinforced polymer is based on Nylon 12.

49. A reinforced polymer blend as defined in claim 42 wherein the strength and modulus of the resultant reinforced copolymer blend is maintained at a value intermediate between the strength and modulus values of the nanocomposite reinforced polymer and the virgin block copolymer.

50. A reinforced polymer blend as defined in claim 42 wherein said nanocomposite reinforced polymer includes nanoparticles of less than 20% by weight.

51. A reinforced polymer blend as defined in claim 42 wherein said nanocomposite reinforced polymer and said virgin block copolymer are blended together with equal amounts by weight.

52. A reinforced polymer blend as defined in claim 42 wherein said nanocomposite reinforced polymer has approximately 5% nanoparticles by weight.

53. A reinforced polymer blend as defined in claim 42 wherein the resultant reinforced polymer blend contains approximately 5% nanoparticles by weight.

54. A reinforced polymer blend as defined in claim 51 wherein the resultant reinforced polymer blend contains approximately 2.5% nanoparticles by weight.

55. A reinforced polymer blend formed by extruding a nanocomposite polymer with its analogous pure virgin polymer into tubing having an inside diameter of 0.001 to 0.500 inches.

56. A method of producing a polymeric material with prespecified stress and strain parameters by diluting of a reinforced nanocomposite polymer blend with pure virgin thermoplastic polymers.

57. The method of producing a polymeric material with prespecified stress and strain parameters as defined in claim 56 wherein the resultant produced polymeric material is extruded into tubular shape having an inside diameter of 0.001 to 0.500 inches.

58. The method of producing a polymeric material with prespecified stress and strain parameters as defined in claim 56 wherein the resultant produced polymeric material is extruded into pellets.

59. The method of producing a polymeric material with prespecified stress and strain parameters as defined in claim 57 wherein said extruding is performed within prespecified temperature conditions to produce the resultant polymeric material with prespecified stress and strain parameters.

60. The method of producing a polymeric material with prespecified stress and strain parameters as defined in claim 59 wherein the extruding is performed at a temperature between 40 degrees to 100 degrees Fahrenheit.

61. The method of producing a polymeric material with prespecified stress and strain parameters as defined in claim 56 wherein the reinforced nanocomposite polymer blend is a polyamide-based thermoplastic nanocomposite.

62. The method of producing a polymeric material with prespecified stress and strain parameters as defined in claim 56 wherein the pure virgin thermoplastic polymer is Nylon-based.

63. The method of producing a polymeric material with prespecified stress and strain parameters as defined in claim 61 wherein the polyamide-based thermoplastic nanocomposite is based on Nylon and the pure virgin thermoplastic polymer is a polyether block amide.

64. The method of producing a polymeric material with prespecified stress and strain parameters as defined in claim 63 wherein the polyamide nanocomposite is based on Nylon 11.

60. The method of producing a polymeric material with prespecified stress and strain parameters as defined in claim 63 wherein the polyamide nanocomposite is based on Nylon 12.

66. The method of producing a polymeric material with prespecified stress and strain parameters as defined in claim 63 wherein the polyamide nanocomposite is based on Nylon 6.
